(19) United States
(12) Patent Application Publication
(10) Pub. No.: US 2009/0211831 A1
(43) Pub. Date: Aug. 27, 2009

(54) SHIFT RANGE SWITCHING CONTROL SYSTEM AND METHOD FOR AUTOMATIC TRANSMISSION OF VEHICLE

(75) Inventor: Yuuichi TAKAMATSU, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/359,493

(22) Filed: Jan. 26, 2009

(30) Foreign Application Priority Data
Feb. 25, 2008 (JP) 2008-43035

(51) Int. Cl. B60K 28/06

(52) U.S. Cl. 180/272

(57) ABSTRACT

In a shift-by-wire type shift range switching control system for an automatic transmission of a vehicle, an alcohol reaction indicated by alcohol concentration in sweat of a driver is checked when an engine of a vehicle is started. If alcohol reaction is detected, a switching inhibit/permit flag is set to “inhibit” so that the shift range switching in the automatic transmission from the parking range to any other ranges and from the neutral range to any travel ranges is inhibited. If the alcohol reaction is detected when the vehicle is in travel, the vehicle is automatically braked to stop and the shift range is to automatically switched from the travel range to the parking range.

### CROSS REFERENCE TO RELATED APPLICATION

This application is based on and incorporates herein by reference Japanese Patent Application No. 2008-43035 filed on Feb. 25, 2008.

### FIELD OF THE INVENTION

The present invention relates to a shift range switching control system and methods which switches shift ranges of an automatic transmission of a vehicle by an electric actuator such as an electric motor.

### BACKGROUND OF THE INVENTION

It is conventionally proposed as systems for inhibiting drunk driving of a vehicle to forcibly stop engine operation (for example, JP 2004-338687A) or disable starting of an engine (for example, JP 8-150853A), when alcohol is detected in a driver. It is also conventionally proposed to detect alcohol from the skin of a person (for example, JP 2001-21567A).

According to the above system for inhibiting drunk driving, a driver cannot start an engine of a vehicle at all after drinking alcohol. As a result, the driver cannot operate even an air conditioner of the vehicle to take a short rest or sleep in such a vehicle after drinking.

It is also proposed (JP 2007-186124A) to lock a shift lever of an automatic transmission to the parking range (parking lock) when alcohol is detected in a driver, so that the driver cannot drive the vehicle.

As a system for switching a shift range of an automatic transmission of a vehicle in response to a shift lever operation by a driver, a shift-by-wire type system is proposed (JP 2000-107905A) that operates a shift range switching mechanism of the automatic transmission by driving an electric actuator in response to the shift lever operation by the driver In this shift-by-wire type system, the electric actuator such as an electric motor is driven in response to a range switching command generated by manual operation on the shift lever, so that the shift range is switched to a new range indicated by the switching command.

According to this shift-by-wire type system, the shift range of the automatic transmission is not switched over directly by manual operation force of a driver on the shift lever and hence the shift lever and the shift range switching mechanism need not be mechanically coupled to each other. Therefore, it is advantageous that this system can be mounted even in a limited space.

According to the system for inhibiting the drunk driving by locking the shift lever, the engine can be started to operate the air conditioner and control a compartment temperature of the vehicle, even when alcohol is detected in the driver. However, a locking mechanism for locking the shift lever is required in addition to an alcohol sensor for detecting alcohol drinking. This locking mechanism will complicate assembling work of the shift range switching control system and add costs.

### SUMMARY OF THE INVENTION

It is therefore an object of the present invention to provide a shift range switching control system and method for an automatic transmission of a vehicle, which automatically inhibits drunk driving of a vehicle.

According to the present invention, a shift range switching control system and method is provided for an automatic transmission of a vehicle having a shift range switching mechanism for switching a shift range of the automatic transmission to a plurality of ranges, which includes a parking range, a neutral range and a travel range, and an electric actuator for actuating the shift range switching mechanism. In this system and method, under a condition that a motive power source of the vehicle is operated, it is checked whether a driver of the vehicle is in a predetermined condition such as alcohol drinking indicating noncompliance for vehicle driving. The shift range switching mechanism is permitted to switch the shift range of the automatic transmission in response to a shift range switching command of the driver, when a result of the checking indicates that the driver is not in the predetermined condition. Driving the vehicle is inhibited while permitting the engine to continue to operate, when a result of the checking indicates that the driver is in the predetermined condition.

The inhibiting may include inhibition of shift range switching from the parking range to any other shift ranges irrespective of the shift range switching command from the driver. The inhibiting may also include automatically braking the vehicle and switching the shift range from the travel range to the parking range irrespective of a drive command from the driver. A notification may be provided to indicate that the travel of vehicle is inhibited because the driver is in the predetermined condition. The notification may be transmitted to a device external to the vehicle together with additional information specifying at least one of the vehicle, location of the vehicle and time of detection of the predetermined condition.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a shift range switching control system according to the first embodiment of the present invention;

FIG. 2 is a schematic view showing an interior arrangement around a driver seat in a vehicle;

FIG. 3 is a schematic view showing a shift range switching mechanism in the first embodiment;

FIG. 4 is a flowchart showing an engine start-time process executed in the first embodiment;

FIG. 5 is a flowchart showing a normal control process executed in the first embodiment;

FIG. 6 is a flowchart showing an in-drive check process executed in the first embodiment; and

FIG. 7 is a flowchart showing an engine start-time process executed in the second embodiment of the present invention.

### DETAILED DESCRIPTION OF THE PREFERRED EMBODIMENT

### First Embodiment

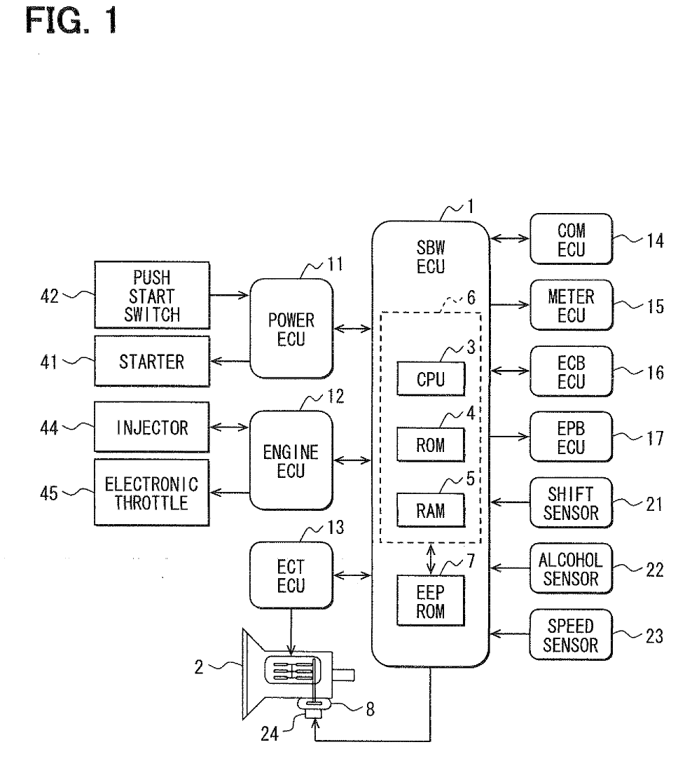

Referring first to FIG. 1, a shift range switching control system includes a shift-by-wire electronic control unit (SBW ECU) 1 for an automatic transmission 2 mounted on a vehicle. The SBW ECU 1 is configured or programmed to control switching of the shift ranges of the automatic transmission 2 to any one of a plurality of shift ranges electronically, that is, by a shift-by-wire method. The shift ranges may include a parking range (P), a neutral range (N), a forward drive range (D) and a reverse drive range (R).

The SBW ECU 1 includes a microcomputer 6, an EEPROM 7 and the like. The microcomputer 6 is constructed with a CPU 3, a ROM 4, a RAM 5 and the like. The EEPROM 7 is a nonvolatile memory that is capable of electrically rewriting its storage contents.

The SBW ECU 1 is connected to a power ECU 11, an engine ECU 12, an electronically-controlled transmission (ECT) ECU 13, a communication ECU 14, a meter ECU 15, an electronically-controlled brake ECU 16, an electric parking brake (EPB) ECU 17, a shift sensor 21, an alcohol sensor 22, a vehicle travel speed sensor 23, an electric actuator 24 such as an electric motor for electrically driving a shift range switching mechanism 8 of the automatic transmission 2 and the like.

The power ECU 11 is configured to control electric power supply to the ECUs 1 and 12 to 17 and control a starter 41 for cranking an engine (not shown), which is a motive power source for travel of the vehicle.

For instance, the power ECU 11 is configured to communicate with a portable device carried by a vehicle driver or user to check whether it is an authorized one. If it is the authorized one and a push start switch 42 is operated, the power ECU 11 turns on a power supply relay (not shown) to supply electric power of a battery (not shown) to the ECUs 1 and 12 to 17. The power ECU 11 further energizes the starter 41 thereby to start the engine after checking and determining that a predetermined engine start permission condition is satisfied.

The engine start permission condition may include that a brake pedal is pressed and the shift range of the automatic transmission 2 is the parking range (P) or the neutral range (N), that is, not the travel range of the forward drive range (D) and the reverse drive range (R).

The SWB ECU 11 is further configured to output shift range information, which indicates a present shift range of the automatic transmission 2, to the power ECU 11, the engine ECU 12, ECT ECU 13, the meter ECU 15 and the like. The power ECU 11 can therefore determine which shift range the present shift range is actually switched to.

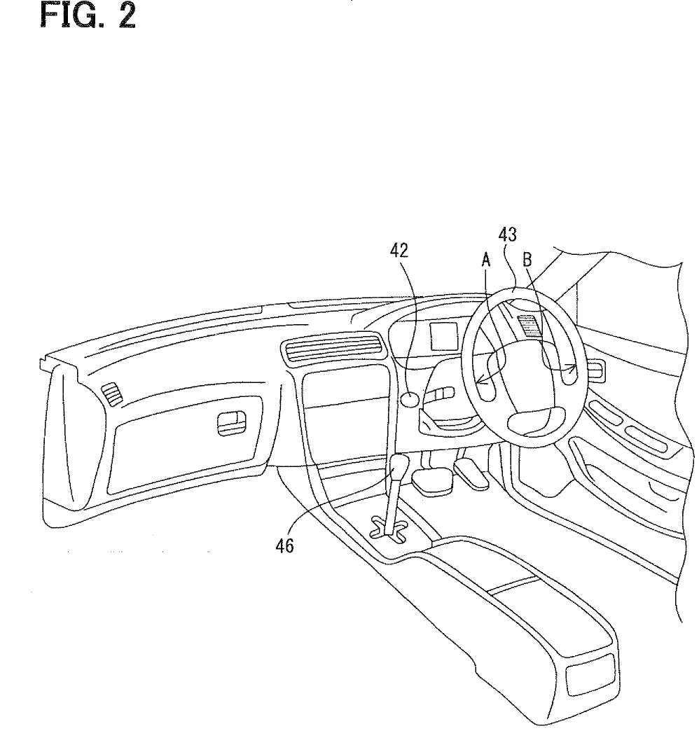

The power ECU 11 is also configured to receive a brake switch signal to check whether a brake pedal is pressed down, that is, the vehicle is at rest. As shown in FIG. 2, the push start switch 42 may be provided near a driver's seat and at a side of a steering wheel 43.

The engine ECU 12 is configured to control the engine by controlling fuel injectors 44 and driving an electronic throttle device 45, which varies the amount of air taken into the engine 2. After the engine is cranked or started by the starter 41, the engine ECU 12 starts its engine control, specifically fuel injection and ignition, in response to crankshaft signals generated by a crankshaft rotation sensor.

The ECT ECU 13 drives shift range switching solenoids provided inside the automatic transmission 2 thereby to control the shift range of the automatic transmission 2, when the shift range is the drive range (D).

The communication ECU 14 is a telematics ECU, which is configured to perform radio communications with external information processing devices through public lines or exclusive lines of cell phones. The meter ECU 15 is configured to control display devices provided in an instrument panel of the vehicle. For example, the meter ECU 15 controls the display devices to display a vehicle travel speed, an engine rotation speed, a coolant temperature and a present shift range of the automatic transmission 2.

The ECB ECU 16 is configured to control a braking operation, and the EPB ECU 17 is configured to control a parking brake of the vehicle. The shift sensor 21 is provided to detect which shift range (position) is a shift lever 46 provided adjacent to the driver's seat in the vehicle as shown in FIG. 2 is operated to. It outputs to the SBW ECU 1 a signal indicating the shift range to which the shift lever 46 is operated and positioned as a shift range command. The shift lever 46 is thus provided as a shift range switching operation part.

The shift lever 46 is operable to the four shift ranges, that is, parking range (P), neutral range (N), forward drive range (D) and reverse drive range (R).

The alcohol sensor 22 is configured to detect alcohol concentration in sweat of a person touching the same, and is located where a driver normally touches while driving. The alcohol sensor 22 is provided on at least one of left and right parts of the steering wheel 43, that is, central parts A and B shown in FIG. 2, which the driver normally continues to hold when driving. The alcohol sensor 22 may alternatively be provided on a top of the shift lever 46.

The alcohol drunkenness depends on the alcohol concentration in blood, and the alcohol concentration in the blood and the alcohol concentration in the sweat have correlation to each other. Therefore, it is possible to determine the drunkenness of a driver based on the alcohol concentration detected by the alcohol sensor 22.

The shift range switching mechanism 8 is for switching the shift range of the automatic transmission 2 to either one of the parking (P), neutral (N), forward drive (D) and reverse drive (R).

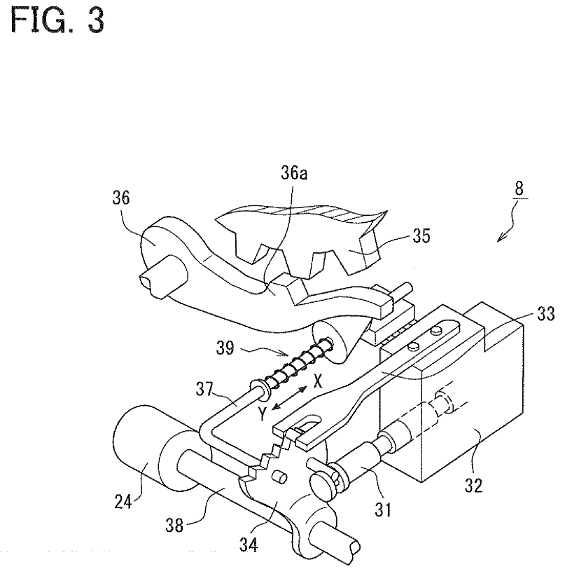

Specifically, as shown in FIG. 3, the shift range switching mechanism 8 is constructed with a switching valve 31, a manual valve 32, a detent spring 33, a fan-shaped detent lever 34, an L-shaped park rod 37, a control rod 38 and a biasing member (spring and park pole contact member) 39. The range switching valve 31 is for switching-controlling a friction engagement device (not shown) provided in the automatic transmission 2 in accordance with the switching of the shift ranges. The detent spring 33 and the detent lever 34 are for maintaining each shift range. A park gear 35 is provided on an output shaft (not shown) of the automatic transmission 2. The park rod 37 is for fitting a park pole 36 in the park gear 35 to stop rotation of the output shaft, when the shift range is switched to the parking range (P). The detent lever 34 is fixed to the control rod 38, which is rotated by the electric actuator 24. The biasing member 39 is provided about the park rod 37 to bias the park pole 36 toward the park gear 35 until the rotational position of the park gear 35 becomes a position, at which a projection 36a of the park pole 36 becomes engageable with the teeth of the park gear 35.

In this shift range switching mechanism 8, when the control rod 38 is rotated by the electric actuator 24, the detent lever 34 is rotated together so that the range switching valve 31 (also the manual valve 32) and the park rod 37 are driven to respective switching range positions. The switching range position can be changed by controlling the amount of rotation of the control rod 34.

For instance, in switching the shift range of the automatic transmission 2 to the parking range (P), the control rod 38 is rotated so that the park rod 37 is moved in the direction X in FIG. 3 thereby to raise the park pole 36 and engage the projection 36a with the park gear 35. As a result, the output shaft of the automatic transmission 2 is disabled to rotate so that a rotation shaft (e.g., a propeller shaft or a drive shaft) for transferring the motive output power of the engine to vehicle tire wheels is also fixed. Thus, the vehicle is inhibited to travel in any of the forward or reverse direction.

When the shift range of the automatic transmission 2 is switched from the parking range (R) to other ranges, the park rod 37 is driven to move in the opposite direction Y in FIG. 3 against the friction force caused by the engagement of the projection 36a with the park gear 35.

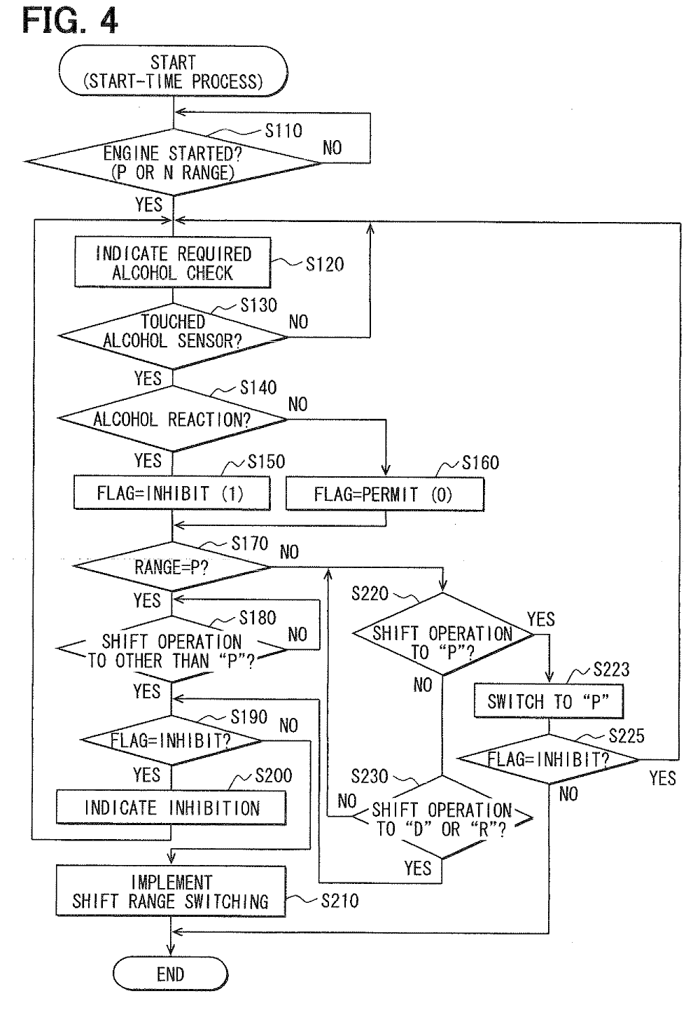

The microcomputer 6, particularly its CPU 3, is programmed to execute the following processes shown in FIG. 4 to FIG. 6.

Referring first to FIG. 4, which shows an engine start-time process executed by the SBW ECU 1 when the electric power is supplied thereto, it is first checked at S110 whether the engine has been started by the starter 41 with the automatic transmission 2 being in the parking range (P) or the neutral range (N). The starting of the engine may be notified by the engine ECU 12.

If the engine has been started (S110: YES), the meter ECU 15 is instructed at S120 to indicate on its display device in the instrument panel that a driver on a driver's seat is required to have an alcohol check. This indication may be made by a message (icon or sentence) or voice. At this moment, the shift range is normally in the parking range (P) or the neutral range (N) because the engine has been just started.

It is then checked at S130 whether the driver has touched the alcohol sensor 22 for the required alcohol check. If the driver touches the alcohol sensor 22, the alcohol sensor 22 produces some changes in its output signal. Therefore, touching the alcohol sensor 22 by the driver may be made by monitoring the output signal change of the alcohol sensor 22. If it is determined that the driver has not touched the alcohol sensor 22 (S130: NO), the indication of alcohol check at S120 is repeated to require the driver to take it.

If the driver has touched the alcohol sensor 22 (S130: YES), it is then checked at S140 whether the output signal of the alcohol sensor 22 represents some alcohol reaction. More specifically, it is checked whether the alcohol concentration in the sweat of the driver is greater than a predetermined threshold level. This checking is for determining whether the driver is in a predetermined condition that is in violation and not in compliance of vehicle driving regulation.

If the alcohol reaction is determined (S140: YES), a shift range switching flag (permit or inhibit) is set to “inhibit,” for instance “1,” at S150. This inhibit flag indicates that the shift range switching is not permitted. If no alcohol reaction is determined (S140: NO), the flag is set to “permit,” for instance “0,” at S160. This permit flag indicates that the shift range switching is permitted as commanded by the driver.

Following S150 or S160, it is further checked at S170 whether the shift range of the automatic transmission 2 at present is the parking range (R). If it is the parking range (S170: YES), that is, the engine has been started under the parking range, S180 is executed. The present shift range may be confirmed within the microcomputer 6, because the microcomputer 6 controls the shift ranges.

At S180, it is checked whether the shift lever 46 is operated by the driver to shift from the parking range (P) to any one of other shift ranges (D, R or N) based on the output signal of the shift sensor 21, which detects the shift position of the shift lever 46. If the shift lever 46 is shifted (S180: YES) from position of the parking range (P), S190 is executed.

At S190, it is checked whether the flag is set to “inhibit (1).” If the flag is “inhibit (1),” S200 is executed. At S200, the meter ECU 15 is instructed to display on the display device in the instrument panel the message indicating that the shift range switching is inhibited because of alcohol reaction of the driver. After S200, the processing returns to S120. It is also possible to sound an alarm with or without the display of message indication at S200.

If it is determined at S190 that the flag is not set to “inhibit (1)” but set to “permit (0)” indicating that the shift range may be switched from the parking range (P), the shift range switching of the automatic transmission 2 from the parking range (P) to the shift range (D, R or N) determined at S180 is implemented by driving the electric actuator 24. Thus, the shift range is actually switched to the shift range to which the driver operated the shift lever 46.

If it is determined at S170 that the shift range is not the parking range (P), that is, the engine has been started in the neutral range (N), S220 is executed.

At S220, it is checked based on the output signal from the shift sensor 21 whether the shift lever 46 has been operated to shift to the parking range (P). If it is determined that the shift lever 46 has been shifted to the parking range (P), the shift range of the automatic transmission 2 is switched to the parking range (P) by driving the electric actuator 24. It is then checked at S225 whether the flag is set to “inhibit (1).” If the flag is not “inhibit” (S225: NO), that is, if it is “permit (0),” the process ends. If the flag is set to “inhibit (1),” the process returns to S120 to repeat the above alcohol check process

If it is determined at S220 that the shift lever 46 has not been shifted to the parking range (P), S230 is executed. Here, it is checked based on the output signal of the shift sensor 21 whether the shift lever 46 has been operated to the position of the forward drive range (D) or the reverse drive range (R). If it is determined at S230 that the shift lever 46 has not been shifted to the position of the forward drive range (D) or the reverse drive range (R), the processing returns to S220.

If it is determined at S230 that the shift lever 46 has been shifted to the position of the forward drive range (D) or the reverse drive range (R), S190 is executed. In this instance, therefore, if the flag is set to “inhibit (1),” the shift range switching is inhibited and the inhibition of shift range switching is indicated at S200. If the flag is not set to “inhibit (1),” the shift range switching is implemented at S210 in correspondence to the operation of the shift lever 46.

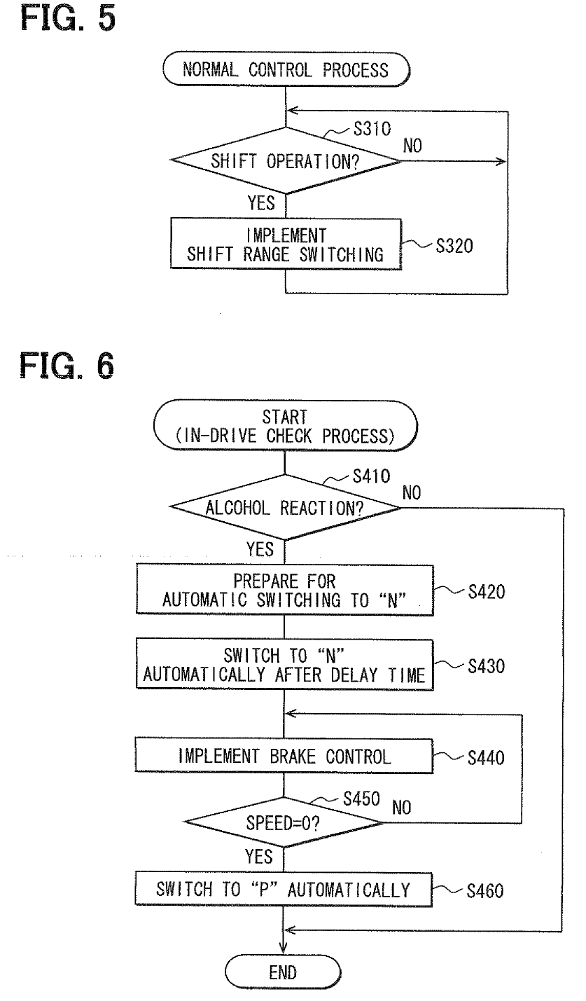

Following S210 (shift range switching implementation) or 5225 (shift range switching permission), the microcomputer 6 executes a normal control process shown in FIG. 5.

Specifically, in the normal control process, it is checked based on the output signal of the shift sensor 21 at S310 whether the shift lever 46 has been shifted to the shift range other than the present shift range of the automatic transmission 2. If it has been shifted (5310: YES), the shift range switching is implemented at S320 so that the electric actuator 24 is driven to switch the shift range from the present range to the different range to which the shift lever 46 is operated.

If the shift range switching is implemented by S210 (FIG. 4) or S320 (FIG. 5), that is, the shift range has been switched to the travel range (forward drive range or reverse drive range) for the vehicle travel, the microcomputer 6 further executes an in-drive check process shown in FIG. 6 to inhibit the drunk driving.

It is first checked at S410 whether the alcohol reaction is detected in the sweat of the driver, in the similar manner as S140 in FIG. 4.

If no alcohol reaction is detected (S410: NO), this in-drive check process ends. If any alcohol reaction is detected (S410: YES), S420 is executed.

At S420, a preparatory process is executed before the shift range of the automatic transmission 2 is switched automatically from the present drive range (D) or the reverse range (R) to the neutral range (N). This preparatory process is for calling attention of the driver of the subject vehicle and other drivers and persons external to the subject vehicle, and may be a display of message on the display in the display panel to indicate that the shift range will soon be automatically switched to the neutral range (N) and flashing of hazard lights or brake lights for external drivers or persons. The indication to the driver of the subject vehicle may be in voice announcement or sound alarm.

At S430, after an elapse of a predetermined delay time, the electric actuator 24 is driven to automatically switch the shift range to the neutral range (N). In this process, the operation (S320 in FIG. 5) of switching the shift range of the automatic transmission 2 to the forward drive range (D) and the reverse drive range (R) is inhibited. For instance, at S430, the inhibition flag may be turned on so that the shift range switching implementation at S320 may be disabled by this inhibition flag even if the shift lever 46 is operated by the driver to the forward drive range (D) or the reverse drive range (R).

At S440 subsequent to S430, a brake instruction is issued to the ECB ECU 16 so that automatic brake control is implemented. Thus, the vehicle is automatically braked to gradually reduce the travel speed of the vehicle.

It is checked at S450 based on the output signal of the travel speed sensor 23 whether the vehicle speed has been reduced to zero. If the speed is not zero (S450: NO), the process returns to S440. If the speed is zero (S450: YES), the shift range of the automatic transmission 2 is automatically shifted to the parking range (P) from the forward drive range (D) or the reverse drive range (R).

As described above, the SBW ECU 1 executes the alcohol check process (S120 to S140) by using the alcohol sensor 22 when the engine is started under the condition that the automatic transmission 2 is in the parking range (P). If the alcohol reaction in the driver is detected (S140: YES), the shift range switching flag is set to “inhibit” (S150). As a result, even if the shift lever 46 is operated by the driver to positions other than the parking range (S180: YES), switching of the shift range for vehicle travel from the parking range (P) is inhibited (S190, S200).

Therefore, even if the drunk driver starts the engine with the automatic transmission 2 in the parking range (P) and operates the shift lever 46 to drive the vehicle, the shift range switching from the parking range (P) to the travel range (D, R) is not effected thus inhibiting travel of the vehicle by the drunk driver.

Further, even if the engine is started with the automatic transmission 2 in the neutral range (N), the vehicle travel by the drunk driver is inhibited in the same manner as described above. In this instance, if the shift lever 46 is operated to the position of the parking range (P), the shift range of the automatic transmission 2 is permitted to be shifted to the parking range (P) without any limitation (S220, S223). However, even if the shift lever 46 is operated to the position of the forward drive range (D) or the reverse drive range (R) for the vehicle travel, the switching of the shift range to such a travel range is inhibited (S230, S190, S200) and not effected in the end.

As a result, although the drunk driver can start the engine for operating the air conditioner, etc., he cannot actually drive the vehicle because the shift range cannot be switched to the travel range (D, R) even if he operates the shift lever 46 to such a travel range.

The drunk driver can start the engine and switch the shift range from the neutral range (N) to the parking range (P). However, he cannot switch the shift range to any of the travel ranges (D, R) even if he operates the shift lever 46.

According to this embodiment, it is not necessary to provide a mechanical lock mechanism to the shift lever 46, thus avoiding complication of assembling work or cost increase.

Further, even if the shift range of the transmission 2 is the travel range (D or R) by which the driver is considered to be driving the vehicle, the drunk driving can be stopped by the in-drive check process (FIG. 6). In this instance, if the driver is determined as having drunk alcohol, the shift range of the automatic transmission 2 is automatically switched to the neutral range (N) and the switching to the travel range (D or R) by the shift lever 46 is inhibited (S430).

It is noted here that the drunk driver may try to drive the vehicle by first letting any other person not drunk to take the start-time alcohol check process (S140 in FIG. 4) and then drive himself in place of such a person. Even in this improper act, the drunk driver will necessarily be subjected to the in-drive alcohol check process (S410 in FIG. 6) once he touches the steering wheel 43. As a result, the drunk driver will never be able to drive the vehicle

It is further noted in the in-drive check process of FIG. 6 that the shift range of the automatic transmission 2 is switched automatically to the parking range (P) after the shift range is automatically switched to the neutral range (S430) and stopped (S440, S450).

This control automatically prevents the vehicle from moving unexpectedly on a down slope or the like.

Alternative to this control, the SWB ECU 1 may instruct the ECB ECU 16 to keep application of braking (S440) or instruct the EPB ECU 17 to apply the parking brake.

In the in-drive check process of FIG. 6, the preparatory process is executed to indicate the drivers inside and the outside the vehicle that the vehicle will travel for some time in the neutral range. This calls attention of the drivers and enhances safety in vehicle travel. This preparatory process may be limited to only one of the drivers of the subject vehicle and the other vehicle.

The vehicle is decelerated at a fast rate by the application of braking force (S440) when the shift range of the automatic transmission 2 is automatically switched to the neutral range (S430). As a result, the vehicle can be quickly and safely stopped.

In the above embodiment, it may be preferred to store in the EEPROM 7 a history (first history information) indicating that the shift range switching has been inhibited (S150, S200) because of detection of alcohol reaction from the driver before the vehicle travels.

Similarly, it may be preferred to store in the EEPROM 7 another history (second history information) indicating that the shift range has been switched automatically to the neutral range (N) because of detection of alcohol reaction from the driver while the vehicle is in travel.

The microcomputer 6 may be programmed such that, if the SWB ECU 1 is connected to a diagnosis device (not shown) and receives a information transmission request from the diagnosis device, the microcomputer 6 transmits the history information stored in the EEPROM 7. If any collision or other accidents arise, it will be readily checked by the diagnosis device based on the first history information whether a drunk driver has tried to operate the vehicle. Further, it will be readily checked based on the second history information whether a drunk driver has operated the vehicle.

Provided that the first history information stored at S150 or S200 in the EEPROM 7 also includes additional information (first additional information) such as time, vehicle total travel distance or vehicle location at the time of alcohol reaction detection, the time or location where the drunk driver tried to drive the vehicle can be readily identified based on such additional information.

Provided further that the second history information stored at S430 or S460 in the EEPROM 7 also includes additional information (second additional information) such as time, vehicle total travel distance or vehicle location at the time of alcohol reaction detection, the time or location where the drunk driver has driven the vehicle can be readily identified based on such additional information.

The time and the total travel distance may be acquired from the meter ECU 15, and the vehicle location may be acquired from a navigation device (not shown) of the vehicle. The first and second additional history information may be stored in a volatile memory backed up by a battery (back-up RAM or standby RAM) in place of the EEPROM 7.

The microcomputer 6 of the SBW ECU 1 may be programmed to automatically transmit notification information (first notification information) from the communication ECU 14 to an external information processing device, when the shift range switching is inhibited (S150, S200) because of detection of alcohol reaction. This notification information preferably includes not only information of inhibition of the shift range switching to other ranges but also vehicle identification information such as a vehicle registration number, chassis number and license plate number.

Similarly, the microcomputer 6 may be programmed to automatically transmit notification information (second notification information) to the external information processing device, when the shift range is automatically switched from the travel range to the neutral range or the parking range (S430, S460) because of detection of the alcohol reaction. This notification information preferably includes not only information of automatic switching from the travel range to the neutral range but also the vehicle identification information.

As a result, by the first notification information, it can be informed from the vehicle to a remote location such as a police station that a drunk driver tired to drive a vehicle. Similarly, by the second notification information, it can be informed that a drunk driver actually drove the vehicle.

The first notification information and the second notification information may be transmitted together with the first additional information and the second additional information, respectively, so that the time and location of the drunk driver's act can also be identified.

The microcomputer 6 may be programmed to instruct the engine ECU 12 at S150 or S200 (FIG. 4) to limit the engine to operate under a predetermined rotation speed irrespective of a drunk driver's accelerator pedal operation. For instance, the engine ECU 12 may be instructed to maintain the throttle position of the electronic throttle device 45.

The microcomputer 6 may also be programmed to instruct the engine ECU 12 at S430 or 5460 (FIG. 6) to limit the engine to operate under a predetermined rotation speed irrespective of a drunk driver's acceleration pedal operation.

As a result, even if the drunk driver erroneously or intentionally operates the accelerator pedal to race the engine, the engine is operated only under the limited speed and hence unnecessary racing of the engine is prevented.

In the case of a vehicle such as an electric vehicle or an engine-motor hybrid vehicle having an electric motor as the motive power source, such an electric motor may also be controlled in the same manner as the engine.

In the first embodiment, S210 (FIG. 4) and S320 (FIG. 5) operate as control means, S120 to S140 (FIG. 4) and S410 (FIG. 6) operate as check means, S150 to S200 (FIG. 4) operate as switching inhibition means, and S420 to S460 (FIG. 6) correspond to travel inhibition means.

### Second Embodiment

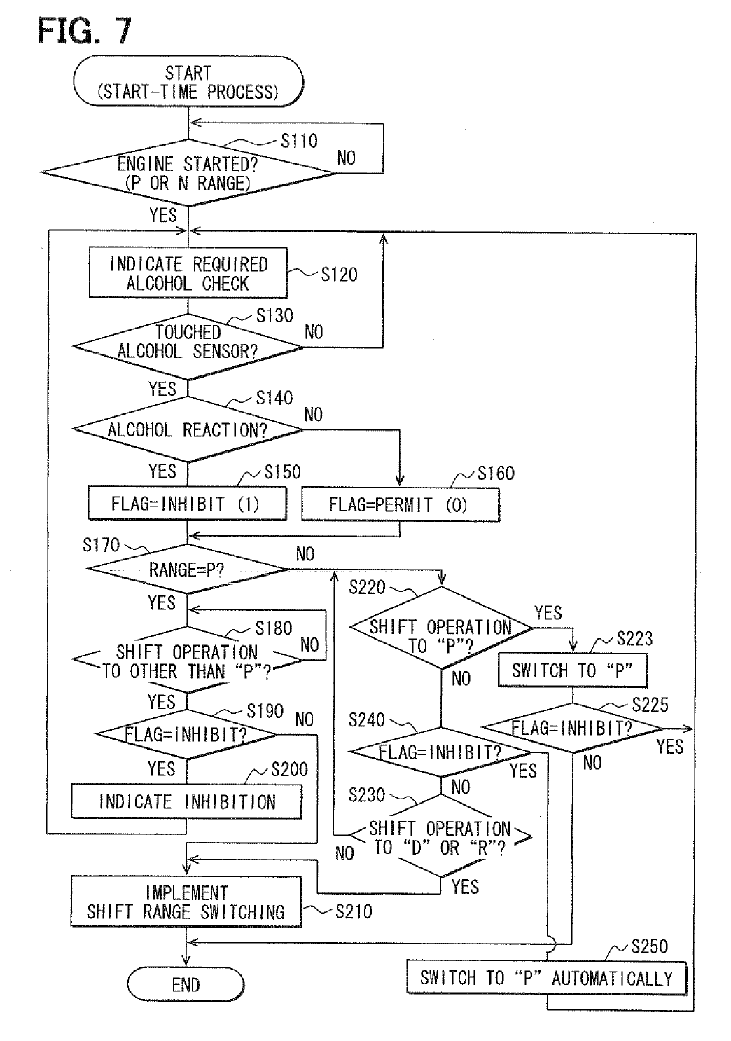

According to the second embodiment, the shift range switching control system is constructed in the similar manner as the first embodiment, but the SW ECU 1 is programmed to execute a start-time process shown in FIG. 7 in place of the start-time process of the first embodiment shown in FIG. 4. The start-time process in the second embodiment is similar to that of the first embodiment, but different in the following three processes (1) to (3).

(1) S240 is provided to be executed when the shift lever 46 has not been operated to shift to the position of parking range (p), that is, when the check result at S220 is NO.

At S240, it is checked whether the switching flag has been set to “inhibit.” If it has not been set to “inhibit” (S240: NO) and set to “permit,” S230 is executed.

(2) If it is determined at S230 that the shift lever 46 has been operated to the position of the travel range, that is, forward drive range (D) or reverse drive range (R), the shift range of the automatic transmission 2 is actually shifted to the range to which the shift lever 46 has been operated. This is because it is confirmed at S240 that the switching flag is set to “permit.”

(3) S250 is also provided to be executed when the check result at S240 indicates that the switching flag is “inhibit.”

At S250, the actuator 24 is driven to implement the automatic switching of the shift range of the automatic transmission 2 from the neutral range (N) to the parking range (P) by confirming that the vehicle travel speed is zero, that is, the vehicle is at rest.

At this time, the meter ECU 15 is instructed to display a message on the display device in the instrument panel. The message indicates that the shift range will be automatically switched to the parking range (P) because of detection of alcohol reaction in the driver. A sound alarm may be provided at S250 with or without the message on the display device.

In the second embodiment, if the alcohol reaction is detected (S140: YES), the shift range of the automatic transmission 2 can be switched from the neutral range (N) to the parking range (P) (S223) in correspondence to the driver's operation on the shift lever 46 (S220: YES). However, the shift range cannot be switched to the forward drive range (D) or the reverse drive range (R) even if the shift lever 46 is operated to shift to the position of such a travel range. This is because the check result at S240 is YES, and S230 is not executed ignoring the driver's operation on the shift lever 46.

If the switching to the forward drive range (D) or the reverse drive range (R) is inhibited under the condition that the shift range is the neutral range (N), the shift range is automatically switched to the parking range (P) without driver's any operation on the shift lever 46 to shift to the position of parking range (P) (S220: NO, S240: YES, S250). This will effectively prevent the vehicle from moving on the down slope.

The processes of storing the first history information, transmitting the first notification information and limiting the engine rotation speed executed at S210 in the first embodiment may also be executed at S250.

The first and the second embodiments may be modified in many other ways.

For instance, the process in FIG. 4 may be executed only when the engine is started under the condition that the shift range of the automatic transmission 2 is either the parking range (P) or the neutral range (N). If it is executed only under the parking range, S220 to S230 may be obviated.

S120 to S230 in FIG. 4 may be executed not only immediately after the engine is started (S110) but also each time the shift range of the automatic transmission 2 is switched from the travel range (D or R) to the neutral range (N) or the parking range (P). In this case, the normal control process (FIG. 5) may be skipped. This modification may be implemented in the process of FIG. 7 as well.

In addition to or in place of the detection of alcohol reaction that will lead to drunk driving and traffic accidents, any other unusual conditions of a driver that will lead to traffic accidents may be detected. Such unusual conditions of the driver will be reactions caused by abuse of illegal drugs, manic as a side effect of normal drugs or bad health conditions. For instance, at S140 (FIG. 4 and FIG. 7) and S410 (FIG. 6), it may be checked whether a driver seems to be sleepy by face images of the driver taken by a camera installed in a vehicle or by analyzing the driver's reaction such as voiced answers made in response to inquiries by voice sound or character display.

What is claimed is:

1. A shift range switching control system for an automatic transmission of a vehicle having a shift range switching mechanism for switching a shift range of the automatic transmission to a plurality of ranges, which includes a parking range, a neutral range and a travel range, and an electric actuator for actuating the shift range switching mechanism, the shift range switching control system comprising:
control means configured to drive the electric actuator in response to a shift range switching command applied to command a shift range switching and controlling the shift range of the automatic transmission to the shift range corresponding to the shift range switching command;
check means configured to check whether a driver of the vehicle is in a predetermined condition indicating noncompliance for vehicle driving; and
switching inhibition means configured to inhibit the control means from implementing the shift range switching to the travel range that allows travel of the vehicle, if the check means determines that the driver is in the predetermined condition when a motive power source of the vehicle is started.

2. The shift range switching control system according to claim 1, further comprising:
memory means configured to store therein history information indicating inhibition of the shift range switching when the shift range switching is inhibited, the memory means being a nonvolatile memory or a volatile memory backed up by a battery.

3. The shift range switching control system according to claim 1, wherein the switching inhibition means is further configured to transmit information indicating inhibition of the shift range switching to a device external to the vehicle while inhibiting the shift range switching.

4. The shift range switching control system according to claim 1, wherein the switching inhibition means is further configured to limit output power of the motive power source of the vehicle to be less than a predetermined power level, while inhibiting the shift range switching.

5. The shift range switching control system according to claim 1, wherein the check means is configured to check whether the driver is in alcohol drinking condition as the predetermined condition.

6. A shift range switching control system for an automatic transmission of a vehicle having a shift range switching mechanism for switching a shift range of the automatic transmission to a plurality of ranges, which includes a parking range, a neutral range and a travel range, and an electric actuator for actuating the shift range switching mechanism, the shift range switching control system comprising:
control means configured to drive the electric actuator in response to a shift range switching command applied to command a shift range switching and controlling the shift range of the automatic transmission to the shift range corresponding to the shift range switching command;
check means configured to check whether a driver of the vehicle is in a predetermined condition indicating noncompliance for vehicle driving; and
switching inhibition means configured to inhibit the control means from implementing the shift range switching to the travel range that allows travel of the vehicle, if the check means determines that the driver is in the predetermined condition when the shift range of the automatic transmission is in the parking range.

7. The shift range switching control system according to claim 6, further comprising:
memory means configured to store therein history information indicating inhibition of the shift range switching when the shift range switching is inhibited, the memory means being a nonvolatile memory or a volatile memory backed up by a battery.

8. The shift range switching control system according to claim 6, wherein the switching inhibition means is further configured to transmit information indicating inhibition of the shift range switching to a device external to the vehicle while inhibiting the shift range switching.

9. The shift range switching control system according to claim 6, wherein the switching inhibition means is further configured to limit output power of the motive power source of the vehicle to be less than a predetermined power level, while inhibiting the shift range switching.

10. The shift range switching control system according to claim 6, wherein the check means is configured to check whether the driver is in alcohol drinking condition as the predetermined condition.

11. A shift range switching control system for an automatic transmission of a vehicle having a shift range switching mechanism for switching a shift range of the automatic transmission to a plurality of ranges, which includes a parking range, a neutral range and a travel range, and an electric actuator for actuating the shift range switching mechanism, the shift range switching control system comprising:
control means configured to drive the electric actuator in response to a shift range switching command applied to command a shift range switching and controlling the shift range of the automatic transmission to the shift range corresponding to the shift range switching command;
check means configured to check whether a driver of the vehicle is in a predetermined condition indicating noncompliance for vehicle driving; and
switching inhibition means configured to inhibit the control means from implementing the shift range switching to a shift range other than the parking range, if the check means determines that the driver is in the predetermined condition when the shift range of the automatic transmission is in the neutral range.

12. The shift range switching control system according to claim 11, wherein the switching inhibition means is further configured to drive the electric actuator for switching the shift range to the parking range automatically, while inhibiting the shift range switching.

13. The shift range switching control system according to claim 11, further comprising:
memory means configured to store therein history information indicating inhibition of the shift range switching when the shift range switching is inhibited, the memory means being a nonvolatile memory or a volatile memory backed up by a battery.

14. The shift range switching control system according to claim 11, wherein the switching inhibition means is further configured to transmit information indicating inhibition of the shift range switching to a device external to the vehicle while inhibiting the shift range switching.

15. The shift range switching control system according to claim 11, wherein the switching inhibition means is further configured to limit output power of the motive power source of the vehicle to be less than a predetermined power level, while inhibiting the shift range switching.

16. The shift range switching control system according to claim 11, wherein the check means is configured to check whether the driver is in alcohol drinking condition as the predetermined condition.

17. A shift range switching control system for an automatic transmission of a vehicle having a shift range switching mechanism for switching a shift range of the automatic transmission to a plurality of ranges, which includes a parking range, a neutral range and a travel range, and an electric actuator for actuating the shift range switching mechanism, the shift range switching control system comprising:
control means configured to drive the electric actuator in response to a shift range switching command applied to command a shift range switching and controlling the shift range of the automatic transmission to the shift range corresponding to the shift range switching command;
check means configured to check whether a driver of the vehicle is in a predetermined condition indicating noncompliance for vehicle driving; and
travel inhibition means configured to drive the electric actuator for switching the shift range to the neutral range automatically and to inhibit the control means from implementing switching of the shift range to the travel range that allows travel of the vehicle in response to the shift range switching command, if the check means determines that the driver is in the predetermined condition when the shift range of the automatic transmission is in the travel range that is other than the parking range and the neutral range and allows travel of the vehicle.

18. The shift range switching control system according to claim 17, wherein the travel inhibition means is further configured to check whether the vehicle is at rest after automatically switching the shift range to the neutral range, and drives the electric actuator for automatically switching the shift range to the parking range.

19. The shift range switching control system according to claim 17, wherein the travel inhibition means is configured to execute a process for calling attention in the vehicle or outside the vehicle, while automatically switching the shift range to the neutral range.

20. The shift range switching control system according to claim 17, wherein the travel inhibition means is configured to brake and decelerate the vehicle, when the shift range is automatically switched to the neutral range.

21. The shift range switching control system according to claim 17, further comprising:
memory means configured to store therein history information indicating automatic switching of the shift range to the neutral range when the shift range is automatically switched to the neutral range, the memory means including one of a nonvolatile memory or a volatile memory backed up by a battery.

22. The shift range switching control system according to claim 17, wherein the travel inhibition means is configured to transmit information indicating automatic switching of the shift range to the neutral range to a device external to the vehicle.

23. The shift range switching control system according to claim 17, wherein the travel inhibition means is configured to limit output power of a motive power source of the vehicle to be less than a predetermined power level when the shift range is switched to the neutral range.

24. The shift range switching control system according to claim 17, wherein the check means is configured to check whether the driver is in alcohol drinking condition as the predetermined condition.

25. A shift range switching control method for an automatic transmission of a vehicle having a shift range switching mechanism for switching a shift range of the automatic transmission to a plurality of ranges, which includes a parking range, a neutral range and a travel range, and an electric actuator for actuating the shift range switching mechanism, the shift range switching control method comprising:
checking whether a driver of the vehicle is in a predetermined condition indicating noncompliance for vehicle driving under a condition that a motive power source of the vehicle is operated;
permitting the shift range switching mechanism to switch the shift range of the automatic transmission in response to a shift range switching command of the driver, when a result of the checking indicates that the driver is not in the predetermined condition; and
inhibiting travel of the vehicle while permitting the engine to continue to operate, when a result of the checking indicates that the driver is in the predetermined condition.

26. The shift range switching control method according to claim 25, wherein the inhibiting includes inhibition of shift range switching from the parking range to any other shift ranges irrespective of the shift range switching command from the driver.

27. The shift range switching control method according to claim 25, wherein the inhibiting includes automatically braking the vehicle and switching the shift range from the travel range to the parking range irrespective of a command from the driver.

28. The shift range switching control method according to claim 25, further comprising:
providing a notification indicating that the travel of vehicle is inhibited because the driver is in the predetermined condition.

29. The shift range switching control method according to claim 25, wherein the proving includes transmission of the notification to a device external to the vehicle together with additional information specifying at least one of the vehicle, location of the vehicle and time of detection of the predetermined condition.

30. The shift range switching control method according to claim 25, wherein the predetermined condition includes alcohol drinking.
